(19) United States
(12) Patent Application Publication
(10) Pub. No.: US 2004/0167819 A1
(43) Pub. Date: Aug. 26, 2004

(54) Gift notification method

(76) Inventor: Kent G. Keating, Amherst, NY (US)

Correspondence Address: George L. Snyder, Jr., Hodgson Russ LLP, Suite 2000, One M&T Plaza, Buffalo, NY, 14203-2391, US

(21) Appl. No.: 10/371,767

(22) Filed: Feb. 21, 2003

(51) Int. Cl. G06F 17/60

(52) U.S. Cl. 705/16

(57) ABSTRACT

A method of providing notification of a gift in advance of delivery of the gift comprises the steps of selling a gift to a purchaser, receiving an instantaneous communication destination from the purchaser, preparing a gift notification that includes an indication of the gift, and transmitting the gift notification to the instantaneous communication destination. The indication of the gift included on the gift notification is preferably a photograph or illustration of the gift, and the instantaneous communication destination is preferably a fax number, an e-mail address, or a printer designation.

### FIELD OF THE INVENTION

The present invention relates generally to retail services for consumer goods and services, and more particularly to a method for providing a gift notification to a gift giver and/or a gift recipient in instances where a purchased gift is not in stock or is unavailable for immediate delivery.

### BACKGROUND OF THE INVENTION

During the holiday season and at other times, shoppers purchasing gifts for others often wait until the last minute to do their shopping. Where a gift item must be shipped, i.e. where the gift item is purchased by mail order catalog or online though a retail website, last minute shoppers are fearful that the gift item will not arrive in time for the gift giving occasion, be it a holiday, a birthday, or some other occasion. Consequently, such shoppers tend toward purchasing a gift at a store location rather than through the mail or online. In fact, a noticeable drop in mail order and online purchases occurs within a week of the Christmas holiday, while store locations remain busy through Christmas Eve.

It is well-known for retailers of consumer goods and services to sell “gift certificates” redeemable by a receiver of the gift certificate at the retailer's place of business or website toward an item of the gift receiver's own choosing. Gift certificates have proven to be very popular, particularly during the holiday shopping season, because they transfer the responsibility for ultimately selecting the particular gift item from the gift giver to the gift receiver, thereby relieving the gift giver of anxiety associated with the selection of a specific gift item. Gift certificates, including, gift certificates transmitted by e-mail to a recipient, are also known. However, gift certificates are viewed by many as an indication that the gift giver has not put as much thought into the gift as would be required in selecting a specific gift item.

### SUMMARY OF THE INVENTION

The present invention is a method of providing notification of a gift in advance of delivery of the gift so that a gift giver has a representation of a purchased gift to present to a gift recipient in the event that the actual gift cannot be delivered in time to meet a deadline, such as a birthday, holiday, wedding, or other gift giving occasion, or where the bulk of a gift makes presentation of the actual gift impractical in a given setting. The method of the present invention generally comprises the steps of selling a gift to a purchaser, receiving an instantaneous communication destination from the purchaser, preparing a gift notification that includes an indication of the gift, and transmitting the gift notification to the instantaneous communication destination. The instantaneous communication destination can be a fax number, an e-mail address, a printer designation, or some other destination for receiving instantaneous transmission of the gift notification. The indication of the gift on the gift notification is preferably an image of the gift, for example a photograph or an illustration of the gift.

The gift notification is preferably prepared using a software template that includes at least one variable content field in which the indication of the gift is inserted during creation of the gift notification. A preferred template provides the gift notification with spaces for entering the names of a gift giver and a gift recipient, and includes a variable content field for displaying an expected delivery date on the gift notification if this information is available. Where the gift notification is transmitted as an attachment file to an e-mail, the e-mail message preferably includes instructions for printing the gift notification.

### BRIEF DESCRIPTION OF THE DRAWINGS

The nature and mode of operation of the present invention will now be more fully described in the following detailed description of the invention taken with the accompanying drawing figures, in which:

FIG. 1 is a plan view of a printed gift notification formed in accordance with a method of the present invention;

FIG. 2 is a plan view of a gift notification template for carrying out a method of the present invention; and

FIG. 3 is a flow chart of a gift notification method of the present invention.

### DETAILED DESCRIPTION OF THE INVENTION

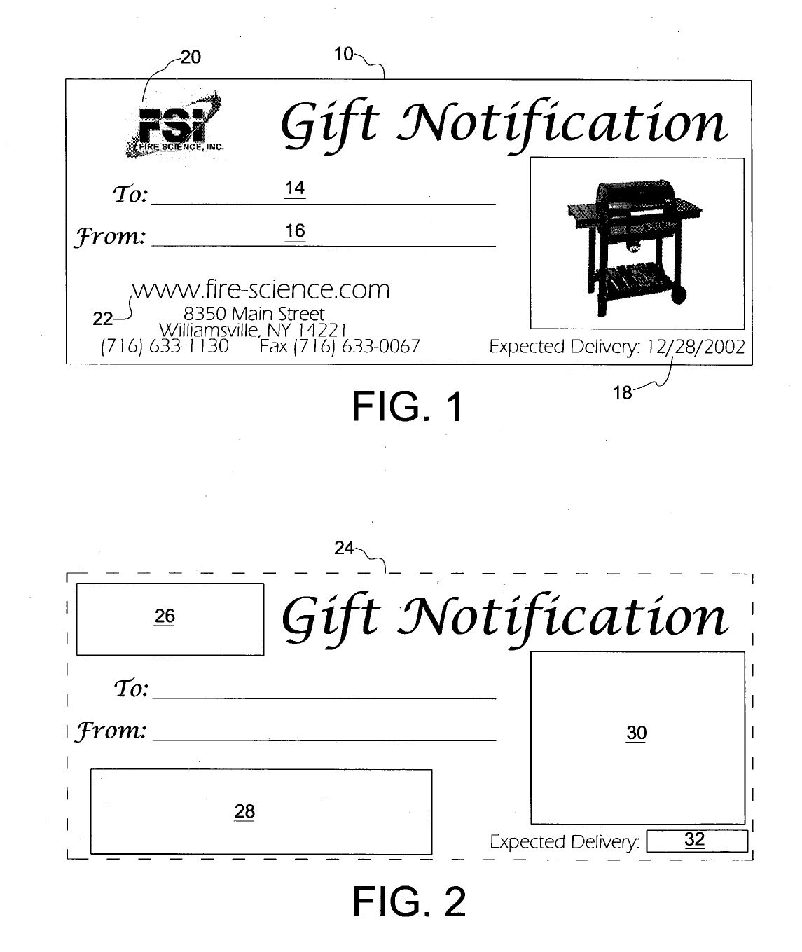

Referring initially to FIG. 1 of the drawings, a gift notification 10 formed in accordance with a method of the present invention is shown. Gift notification 10 includes an image 12 of a gift purchased by a gift giver so as to provide an indication of the gift to an intended gift recipient. For example, in FIG. 1, the purchased gift is a gas grill. Gift notification 10 further includes a space 14 for entering the name of the gift giver, and a space 16 for entering the name of a gift recipient. When possible, an expected delivery date 18 is preferably printed on gift notification 10 to inform the gift recipient of a targeted delivery date of the actual gift. Gift notification 10 also includes information for identifying where the gift was purchased, for example a business logo 20 and contact information 22.

FIG. 2 is a representation of an electronic gift notification template 24 used to generate gift notification 10 according to an embodiment of the invention. Template 24 includes fields 26, 28, 30, and 32 for displaying business logo 20, contact information 22, image 12, and expected delivery date 18, respectively. Fields 26 and 28 can be variable content fields if different retailers are using the same gift notification template 24, or they can be fixed fields or permanent labels built into the template if a single retailer is using the template. Field 30 is a variable content image or picture field in which a chosen digital image, such as a JPEG image, of the gift is displayed. Field 32 is a variable content text field in which the expected delivery date of the purchased gift is displayed. Template 24 can be created using any of a variety of commercially available software programs, including but not limited to Microsoft Word and ADOBE ACROBAT®.

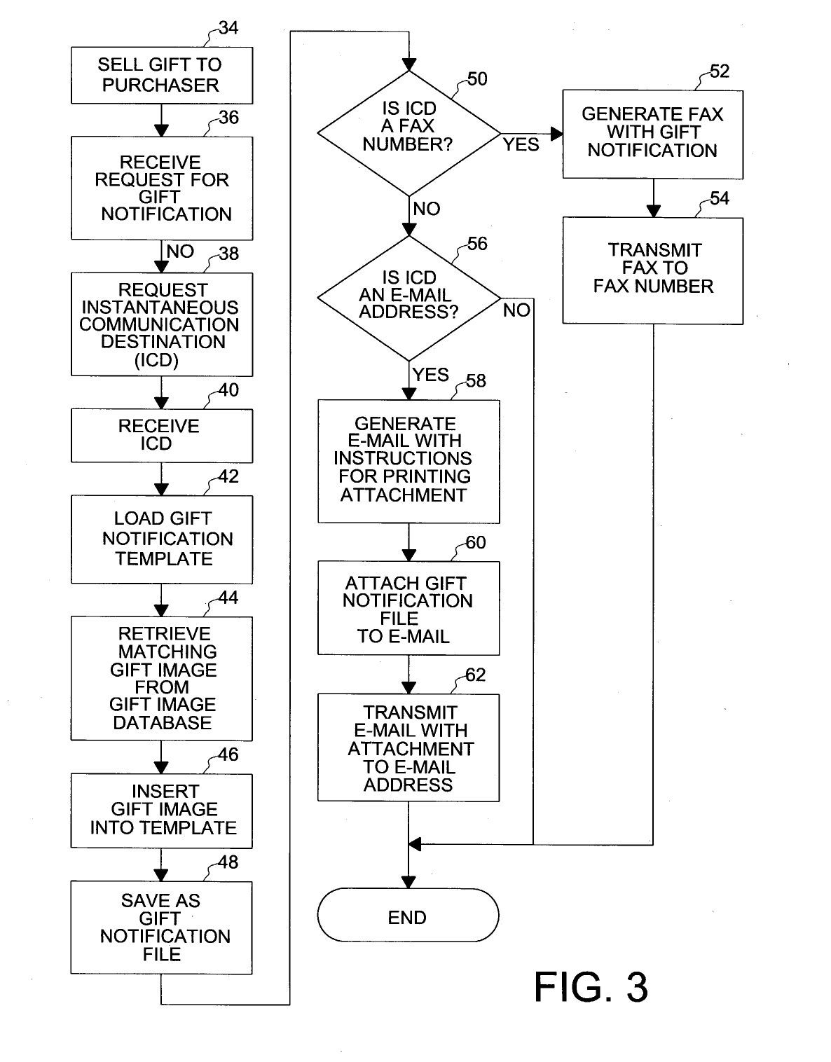

FIG. 3 is a flow diagram illustrating a gift notification method of the present invention. The method begins in block 34 with the step of selling a gift to a purchaser. The purchaser can request a gift notification from the vendor, as indicated in block 36. The vendor, as part of a gift notification request form or a similar information prompt, asks the purchaser for an instantaneous communication destination (ICD) to which the gift notification can be transmitted, pursuant to block 38. Under present technology, the ICD is typically an e-mail address or a facsimile (“fax”) number which is supplied by the purchaser for receiving the gift notification in hard copy or electronic format. While e-mail and fax transmission of the gift notification are currently provided for in the present method, other technologies, including later invented technologies for instantaneous transmissions, are contemplated for use in practicing the present invention. In block 40, the vendor receives the ICD from the purchaser.

Referring now to blocks 42, 44, 46 and 48, creation of a customized gift notification is carried out. In block 42, a gift notification template such as that described above in connection with FIG. 2 is loaded or accessed by a vendor computer system. Then, in block 44, the vendor searches for an image of the purchased gift in an image library of items offered for sale by the vendor, and retrieves a located gift image. The retrieved gift image is then inserted into the gift image field of the template according to block 46. The steps of blocks 44 and 46 can be done manually, for example by a “copy and paste” operation performed by an operator, but it is preferable to program an image retrieval routine that can automatically retrieve the correct image based on bar code or purchased item data already available from the purchase transaction and insert the gift image into the gift notification template. Although not shown in FIG. 3, it is also possible for the vendor to retrieve inventory and lead time information from an inventory database system to compute an estimated delivery date, which can depend on a chosen delivery option (public mail, private carrier, etc.), so that the estimated delivery date can be inserted into a text field in the template. Pursuant to block 48, a gift notification file is saved from the filled-in template.

Block 50 is a query step to determine whether or not the ICD supplied by the purchaser is a fax number. If the ICD is a fax number, a fax that includes the gift notification is generated using the created gift notification file, as indicated in block 52. Then, according to block 54, the fax is transmitted to the ICD fax number. Consequently, the purchaser or a gift giver associated with the ICD receives a gift notification by fax just moments after the gift purchase transaction, in advance of actual delivery of the gift item. The gift notification is thus immediately available for presentation to a gift recipient.

If the ICD is not a fax number, then another query step (block 56) is executed to determine whether or not the ICD is an e-mail address. If the ICD is an e-mail address, then an e-mail is created in block 58 for transmission to the e-mail address. Preferably, the e-mail message includes explicit instructions for opening and printing an attached gift notification file, depending on the file type of the gift notification file. Pursuant to blocks 60 and 62, the gift notification file is attached to the e-mail as a file attachment, and then the e-mail with attached gift notification file is transmitted to the e-mail address. The purchaser or gift giver associated with the e-mail address receives the e-mail moments after the gift purchase transaction, and can open and print the gift notification file. Consequently, the gift notification is immediately available for presentation to the gift recipient.

As will be appreciated by the reader, the method of the present invention is useful for internet transactions, mail and/or phone order catalog transactions, and traditional retail store transactions. For internet orders, a gift notification can be generated if the purchaser checks a box at the time credit card information is supplied. For retail store transactions, it should be realized that the instantaneous communication destination may be the store's own printer connected to a store computer system, whereby a gift notification is generated on the spot and given to the purchaser if an item is currently out of stock.

What is claimed is:

1. A method of providing notification of a gift in advance of delivery of said gift, said method comprising the steps of:
selling a gift to a purchaser;
receiving an instantaneous communication destination from said purchaser;
preparing a gift notification, said gift notification including an indication of said gift; and
transmitting said gift notification to said instantaneous communication destination.

2. The method according to claim 1, wherein said instantaneous communication destination is a facsimile number.

3. The method according to claim 1, wherein said instantaneous communication destination is an e-mail address.

4. The method according to claim 1, wherein said instantaneous communication destination is a printer.

5. The method according to claim 3, wherein said gift notification is transmitted as an e-mail attachment file.

6. The method according to claim 1, wherein said indication of said gift is an image of said gift.

7. The method according to claim 6, wherein said step of preparing said gift notification includes selecting said image from a plurality of images each showing a different item offered for sale.

8. The method according to claim 1, wherein said step of preparing said gift notification includes accessing a standardized gift notification template having at least one variable content field, and said indication of said gift is provided in a variable content field of said template.

9. The method according to claim 8, wherein said gift notification includes a space for entering the name of a gift giver.

10. The method according to claim 8, wherein said gift notification includes a space for entering the name of a gift recipient.

11. The method according to claim 8, wherein said gift notification includes an expected delivery date for said gift provided in a variable content field of said template.

12. The method according to claim 1, further comprising the step of transmitting instructions for printing said gift notification to said instantaneous communication destination.
